(19) United States
(12) Patent Application Publication
(10) Pub. No.: US 2013/0050383 A1
(43) Pub. Date: Feb. 28, 2013

(54) THERMAL HEAD, METHOD OF PRODUCING THERMAL HEAD, AND THERMAL PRINTER

(71) Applicants: Norimitsu Sanbongi, Chiba-shi (JP); Kazuo Tani, Chiba-shi (JP); Yoshinori Sato, Chiba-shi (JP)

(72) Inventors: Norimitsu Sanbongi, Chiba-shi (JP); Kazuo Tani, Chiba-shi (JP); Yoshinori Sato, Chiba-shi (JP)

(21) Appl. No.: 13/590,575

(22) Filed: Aug. 21, 2012

(30) Foreign Application Priority Data
Aug. 23, 2011 (JP) 2011-181939

(51) Int. Cl. B05D 5/12; B41J 2/32

(52) U.S. Cl. 347/171; 427/58

(57) ABSTRACT

A thermal head for expressing pressure-sensitive adhesive strength includes a heat-generating element on a principal plane of a substrate and heats a thermosensitive pressure-sensitive adhesive layer of a thermosensitive pressure-sensitive adhesive label. A thermally active component adhesion preventing layer that comes into sliding contact with the thermosensitive pressure-sensitive adhesive layer is formed on the principal plane of the substrate on an upstream side and a downstream side of the heat-generating element in a conveyance direction of the thermosensitive pressure-sensitive adhesive label, and a surface of the thermally active component adhesion preventing layer is formed along an outer circumferential surface of a second platen roller.

### RELATED APPLICATIONS

This application claims priority under 35 U.S.C. §119 to Japanese Patent Application No. 2011-181939 filed on Aug. 23, 2011, the entire content of which is hereby incorporated by reference.

### BACKGROUND OF THE INVENTION

1. Field of the Invention

The present invention relates to a thermal head, a method of producing a thermal head, and a thermal printer including a thermal head.

2. Description of the Related Art

Conventionally, an adhesive label has been used, for example, as a food POS label, a distribution/transport label, a medical label, a baggage tag, or a display label for bottles and cans. The adhesive label has a pressure-sensitive adhesion surface provided with a pressure-sensitive adhesive layer on a reverse side of a recording surface (printing surface). The adhesive label is stored with release paper (separator) provisionally attached to the pressure-sensitive adhesion surface and is used after the separator is detached from the pressure-sensitive adhesion surface. However, there is a problem that a separator detached from the pressure-sensitive adhesion surface during use of the adhesive label becomes an industrial waste.

In recent years, a thermosensitive pressure-sensitive adhesive label that does not use a separator is known. The thermosensitive pressure-sensitive adhesive label is provided with a thermosensitive pressure-sensitive adhesive layer having no pressure-sensitive adhesiveness at room temperature on a reverse surface of a recording surface of a thermosensitive coloring type, and the thermosensitive pressure-sensitive adhesive layer expresses pressure-sensitive adhesive strength when heated.

As a printer for printing and issuing the above-mentioned type of thermosensitive pressure-sensitive adhesive label, a thermal printer including a thermal head that uses a plurality of heat-generating elements as a heat source is known. In the thermal printer, a thermosensitive pressure-sensitive adhesive label is conveyed while being interposed between a platen roller and a thermal head, and the thermal head is brought into sliding contact with a thermosensitive pressure-sensitive adhesive layer of the traveling thermosensitive pressure-sensitive adhesive label to heat the thermosensitive pressure-sensitive adhesive layer, to thereby allow the layer to express pressure-sensitive adhesive strength.

The surface of the thermal head is constantly in contact with the thermosensitive pressure-sensitive adhesive layer. Therefore, there is a problem that a thermally active component such as a thermosensitive pressure-sensitive adhesive or a denatured substance of a thermosensitive pressure-sensitive adhesive (substance changed chemically with heat or carbonized substance) adheres to the surface of the thermal head. The thermally active component adhering to the surface of the thermal head causes resistance to the conveyance of the thermosensitive pressure-sensitive adhesive label, which may cause suspension or bending of a traveling thermosensitive pressure-sensitive adhesive label, or a conveyance failure such as paper jam. Further, the thermally active component adhering to the surface of the thermal head hinders the transmission of heat, and hence, a heat conduction efficiency may be degraded.

FIG. 13 is an explanatory diagram of a conventional thermal head 10 for expressing pressure-sensitive adhesive strength.

In order to solve the above-mentioned problems, as illustrated in FIG. 13, the thermal head 10 for expressing pressure-sensitive adhesive strength has been proposed in which a heat-generating element 14 is covered with a protective layer 18, and two lines of thermally active component adhesion preventing layers 20 are provided on an upper surface of the protective layer 18 to be substantially in parallel to each other so as to sandwich a region right above the heat-generating element 14.

As illustrated in FIG. 13, in the thermal head 10 for expressing pressure-sensitive adhesive strength, the thermally active component adhesion preventing layers 20 are formed in two rows with the region right above the heat-generating element 14 opened. Therefore, a step 21 provided by the thermally active component adhesion preventing layer 20 is formed on each of an upstream side and a downstream side of the heat-generating element 14.

When the thermosensitive pressure-sensitive adhesive label 5 is conveyed by a platen roller 53, the thermosensitive pressure-sensitive adhesive label 5 comes into sliding contact with the step 21 of the thermally active component adhesion preventing layer 20. Therefore, the thermally active component D adhering to the thermosensitive pressure-sensitive adhesive label 5 is caught on the step 21 to remain in a gap between the platen roller 53 and the protective layer 18 and may adhere to the region above the heat-generating element 14 and the periphery of the heat-generating element 14.

### SUMMARY OF THE INVENTION

According to an exemplary embodiment of the present invention, there is provided a thermal head, including a heat-generating element on a principal plane of a substrate, the thermal head being configured to heat a thermosensitive layer of a thermosensitive label conveyed while being interposed between the heat-generating element and a platen roller opposed to the heat-generating element, in which the principal plane of the substrate has a thermally active component adhesion preventing layer formed thereon, which comes into sliding contact with the thermosensitive layer and is formed at least on an upstream side and a downstream side of the heat-generating element in a conveyance direction of the thermosensitive label, and in which a surface of the thermally active component adhesion preventing layer is formed in a shape following an outer circumferential surface of the platen roller.

According to the above-mentioned thermal head, the surface of the thermally active component adhesion preventing layer is formed along the outer circumferential surface of the platen roller without any step. Therefore, when the thermosensitive label is conveyed while being interposed between the platen roller and the heat-generating element, the thermosensitive layer of the thermosensitive label and the surface of the thermally active component adhesion preventing layer can come into surface contact with each other. Herein, the thermally active component adhesion preventing layer has a property of preventing the adhesion of the thermally active component. Therefore, the thermally active component adhering to the thermosensitive layer of the thermosensitive label is conveyed to the downstream side of the heat-generating element to be removed from the region right above and the periphery of the heat-generating element without being caught on the surface of the thermally active component adhesion preventing layer or remaining in a gap between the platen roller and the thermally active component adhesion preventing layer.

Thus, the thermally active component can be prevented from remaining and from adhering to the region right above the heat-generating element and the periphery of the heat-generating element.

Further, in the thermal head, the thermally active component adhesion preventing layer is formed continuously between the upstream side and the downstream side of the heat-generating element in the conveyance direction, and in which the surface of the thermally active component adhesion preventing layer is formed in the shape following the outer circumferential surface of the platen roller between the upstream side and the downstream side of the heat-generating element in the conveyance direction.

According to the above-mentioned thermal head, the thermally active component adhesion preventing layer is formed so as to cover the heat-generating element. Therefore, the thermally active component can be reliably prevented from adhering to the surface of the thermally active component adhesion preventing layer corresponding to the heat-generating element.

Further, the surface of the thermally active component adhesion preventing layer is formed along an outer circumferential shape of the platen roller between the upstream side and the downstream side of the heat-generating element in the conveyance direction of the thermosensitive label, and hence, the thermosensitive layer of the thermosensitive label and the thermally active component adhesion preventing layer are brought into surface contact with each other in a wide range without any step from the upstream side to the downstream side. Thus, the thermally active component can be conveyed to the downstream side of the heat-generating element to be removed reliably without being caught on the surface of the thermally active component adhesion preventing layer. Further, a gap is not formed between the platen roller and the thermally active component adhesion preventing layer, and hence, the thermally active component does not remain in a gap between the platen roller and the thermally active component adhesion preventing layer.

Thus, the thermally active component can be reliably prevented from remaining and from adhering to the region above the heat-generating element and the periphery of the heat-generating element.

Further, the surface of the thermally active component adhesion preventing layer is formed along the outer circumferential shape of the platen roller, and hence, the surface is formed substantially in an arc shape between the upstream side and the downstream side of the heat-generating element in the conveyance direction of the thermosensitive label. Therefore, the portion of the thermally active component adhesion preventing layer corresponding to the heat-generating element is formed thinner compared with portions corresponding to the upstream side and the downstream side in the conveyance direction of the thermosensitive label. Thus, a decrease in a heat conduction efficiency is suppressed when heat is transmitted from the heat-generating element to the thermosensitive layer via the thermally active component adhesion preventing layer.

Further, in the thermal head, the thermally active component adhesion preventing layer contains one of a silicone-based resin and a fluorine-based resin as a main component.

According to the above-mentioned thermal head, the thermally active component adhesion preventing layer that has low surface energy and is excellent in water repellency and oil repellency can be formed. Thus, the thermally active component adhering to the thermosensitive layer of the thermosensitive label can be conveyed to the downstream side of the heat-generating element together with the conveyance of the thermosensitive label to be removed reliably without being caught on the surface of the thermally active component adhesion preventing layer or remaining. Therefore, the thermally active component can be prevented from adhering to the region above the heat-generating element and the periphery of the heat-generating element.

Further, in the thermal head, the thermally active component adhesion preventing layer contains, as a main component, a material obtained by adding powder of one of an oxide, a nitride, and an oxynitride of one of silicon, a silicon-based alloy, titanium, a titanium-based alloy, tantalum, and a tantalum-based alloy to a fluorine-based resin.

According to the above-mentioned thermal head, the abrasion resistance of the thermally active component adhesion preventing layer can be enhanced while water repellency and oil repellency are kept. Thus, a thermal head can be provided, which is capable of preventing the thermally active component from adhering to the region above the heat-generating element and the periphery of the heat-generating element and which is excellent in abrasion resistance.

Further, in the thermal head, the thermally active component adhesion preventing layer contains, as a main component, a material obtained by adding one of metal and carbon to a fluorine-based resin.

According to the above-mentioned thermal head, the thermally active component adhesion preventing layer is allowed to have conductivity while keeping water repellency and oil repellency by adding metal or carbon to form the thermally active component adhesion preventing layer. Thus, static electricity generated when the thermosensitive label and the thermally active component adhesion preventing layer come into sliding contact with each other can be discharged from the thermally active component adhesion preventing layer. Thus, the thermally active component can be prevented from adhering to the region above the heat-generating element and the periphery of the heat-generating element due to static electricity, and electrostatic breakdown of an electronic element such as the heat-generating element can be prevented.

Further, the thermal head, the thermosensitive label is a thermosensitive pressure-sensitive adhesive label, and the thermosensitive layer is a thermosensitive pressure-sensitive adhesive layer for expressing pressure-sensitive adhesive strength by heating.

According to the above-mentioned thermal head, the thermally active component adhesion preventing layer has a property of preventing the adhesion of the thermally active component. Therefore, even a thermally active component having pressure-sensitive adhesiveness is conveyed to the downstream side of the heat-generating element together with the movement of the thermosensitive label to be removed without being caught on the surface of the thermally active component adhesion preventing layer. Thus, the thermally active component adhesion preventing layer is preferred for a thermosensitive pressure-sensitive adhesive label provided with a thermosensitive pressure-sensitive adhesive layer that expresses pressure-sensitive adhesive strength by heating.

Further, a method of producing a thermal head according to an exemplary embodiment of the present invention includes a heat-generating element on a principal plane of a substrate, the thermal head being configured to heat a thermosensitive layer of a thermosensitive label conveyed while being interposed between the heat-generating element and a platen roller opposed to the heat-generating element, the method including forming a thermally active component adhesion preventing layer that comes into sliding contact with the thermosensitive layer on the principal plane of the substrate at least on an upstream side and a downstream side of the heat-generating element in a conveyance direction of the thermosensitive label, in which the forming a thermally active component adhesion preventing layer includes: forming a base layer of the thermally active component adhesion preventing layer on the principal plane of the substrate so that the base layer overlaps the heat-generating element; and after forming the base layer, forming a surface along an outer circumferential surface of the platen roller by processing the base layer at least on the upstream side and the downstream side of the heat-generating element in the conveyance direction of the thermosensitive label.

According to the related art, it is necessary to form a base layer of a thermally active component adhesion preventing layer by masking the positions corresponding to the heat-generating elements so that the thermally active component adhesion preventing layer is not formed in a region right above the heat-generating element, for the purpose of preventing a decrease in a heat conduction efficiency. The mask is formed by, for example, photolithography, and hence, the step is very complicated. However, according to the above-mentioned method, after the base layer of the thermally active component adhesion preventing layer is formed so as to overlap the heat-generating elements, the surface processing is performed along the outer circumferential surface of the platen roller. Therefore, it is not necessary to mask the positions corresponding to the heat-generating elements. Thus, the thermally active component adhesion preventing layer having the surface along the outer circumferential surface of the platen roller can be formed easily.

Further, in the related art, in order to ensure a satisfactory heat conduction efficiency, it is necessary to form the thermally active component adhesion preventing layer thin. Therefore, a material for forming the thermally active component adhesion preventing layer is limited to, for example, a silicone-based resin. However, according to the above-mentioned method, the thick base layer is processed to form the surface of the thermally active component adhesion preventing layer. Therefore, the center portion of the thermally active component adhesion preventing layer can be formed to a desired thickness by adjusting a processing amount. Further, the base layer before processing can be formed thick, and hence, the material for forming the thermally active component adhesion preventing layer is not limited, and a thermal head having a desired heat conduction efficiency can be formed.

Further, the method of producing a thermal head, the forming a surface includes bringing an outer circumferential surface of a polishing roller having a diameter substantially equal to a diameter of the platen roller into contact with the base layer to polish the base layer.

According to the above-mentioned method, the outer circumferential surface of the polishing roller has a diameter substantially equal to that of the platen roller. Therefore, the surface of the thermally active component adhesion preventing layer having a shape following the outer circumferential surface of the platen roller can be formed easily with good precision merely by polishing the base layer with the polishing roller.

Further, the polishing amount can be adjusted easily, and hence, the base layer covering the heat-generating elements can be formed to a desired thickness and the heat-generating elements can be exposed from the base layer. Thus, a thermal head having a desired heat conduction efficiency can be formed.

Further, in the method of producing a thermal head, the forming a surface includes bringing a side surface of a disk grinder into contact with the base layer to polish the base layer, and the side surface of the disk grinder is formed on a curved surface having a radius of curvature substantially equal to a radius of curvature of the outer circumferential surface of the platen roller.

According to the above-mentioned method, the side surface of the disk grinder is formed on the curved surface having a radius of curvature substantially equal to that of the platen roller. Therefore, the surface of the thermally active component adhesion preventing layer having a shape following the outer circumferential surface of the platen roller can be formed easily with good precision merely by polishing the base layer with the disk grinder. Further, in the same way as described above, the polishing amount can be adjusted easily, and hence, a thermal head having a desired heat conduction efficiency can be formed.

Further, in the method of producing a thermal head, the forming a surface includes pressing an outer circumferential surface of a die against the base layer, and the outer circumferential surface of the die is formed on a curved surface having a radius of curvature substantially equal to a radius of curvature of the outer circumferential surface of the platen roller.

According to the above-mentioned method, the outer circumferential surface of the die is formed on the curved surface having a radius of curvature substantially equal to that of the platen roller. Therefore, the surface of the thermally active component adhesion preventing layer having a shape following the outer circumferential surface of the platen roller can be formed easily with good precision merely by pressing the outer circumferential surface of the die against the base layer.

Further, the base layer covering the heat-generating elements can be formed to a desired thickness by adjusting the pressure force of the die. Therefore, a thermal head having a desired heat conduction efficiency can be formed.

Further, in the method of producing a thermal head, the forming a surface includes conveying a polishing sheet with the platen roller and bringing the polishing sheet into sliding contact with the base layer to polish the base layer.

According to the above-mentioned method, the surface of the thermally active component adhesion preventing layer having a shape following the outer circumferential surface of the platen roller can be formed easily with good precision without using a tool. Further, the polishing amount can be adjusted easily, and hence, the base layer covering the heat-generating elements can be formed to a desired thickness and the heat-generating elements can be exposed from the base layer. Thus, a thermal head having a desired heat conduction efficiency can be formed.

A thermal printer according to an exemplary embodiment of the present invention includes the above-mentioned thermal head.

According to the printer, a high performance thermal printer having a high heat conduction efficiency is obtained without any conveyance defects of a thermosensitive label by providing a thermal head capable of preventing a thermally active component from adhering to a region above a heat-generating element and the periphery of the heat-generating element.

According to the printer, the surface of the thermally active component adhesion preventing layer is formed along the outer circumferential surface of the platen roller without any step. Therefore, when the thermosensitive label is conveyed while being interposed between the platen roller and the heat-generating element, the thermosensitive layer of the thermosensitive label and the surface of the thermally active component adhesion preventing layer can come into surface contact with each other. Herein, the thermally active component adhesion preventing layer has a property of preventing the adhesion of the thermally active component. Therefore, the thermally active component adhering to the thermosensitive layer of the thermosensitive label is conveyed to the downstream side of the heat-generating element to be removed from the region right above and the periphery of the heat-generating element without being caught on the surface of the thermally active component adhesion preventing layer or remaining in a gap between the platen roller and the thermally active component adhesion preventing layer.

Thus, the thermally active component can be prevented from remaining and from adhering to the region above the heat-generating element and the periphery of the heat-generating element.

### BRIEF DESCRIPTION OF THE DRAWINGS

In the accompanying drawings:

FIG. 1 is a schematic view of a thermal printer;

FIG. 2 is a plan view of a thermal head for expressing pressure-sensitive adhesive strength;

FIG. 3 is a cross-sectional perspective view of the thermal head for expressing pressure-sensitive adhesive strength;

FIG. 4 is a cross-sectional side view taken along line A-A of FIG. 2;

FIG. 5 is a cross-sectional side view of a thermal head for expressing pressure-sensitive adhesive strength in a first modified example of an embodiment of the present invention;

FIG. 6 is a cross-sectional side view of a thermal head for expressing pressure-sensitive adhesive strength in a second modified example of the embodiment;

FIG. 7 is a flowchart of a method of producing a thermal head for expressing pressure-sensitive adhesive strength;

FIG. 8 is an explanatory diagram of a base layer formation step;

FIG. 9 is an explanatory diagram of a surface formation step;

FIG. 10 is an explanatory diagram of a surface formation step using a disk grinder;

FIG. 11 is an explanatory diagram of a surface formation step using a die;

FIG. 12 is an explanatory diagram of a surface formation step using a polishing sheet; and

FIG. 13 is an explanatory diagram of a conventional thermal head for expressing pressure-sensitive adhesive strength.

### DETAILED DESCRIPTION OF THE PREFERRED EMBODIMENT

Hereinafter, a thermal head according to an embodiment of the present invention is described with reference to the drawings.

In the following, first, an outline of a thermal printer is described, and then, a thermal head of this embodiment is described.

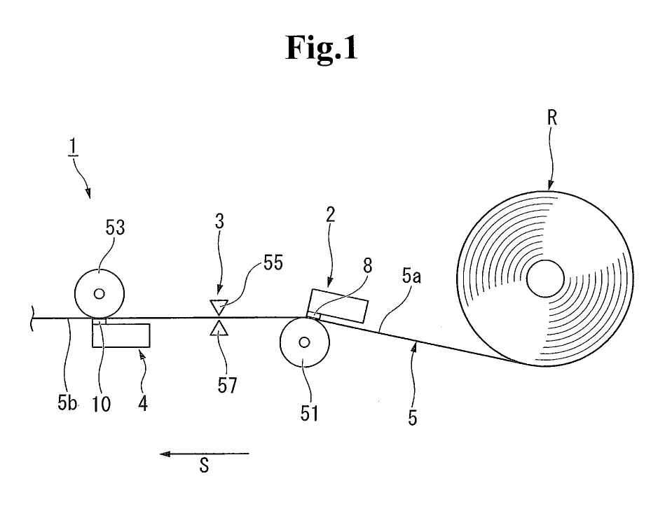

FIG. 1 is a schematic view of a thermal printer 1.

As illustrated in FIG. 1, a thermal printer 1 prints a barcode, a price, or the like on one surface of a thermosensitive pressure-sensitive adhesive label 5 (thermosensitive label) unrolled from a sheet roll R and conveyed, cuts the thermosensitive pressure-sensitive adhesive label 5 to a desired length, causes the other surface of the thermosensitive pressure-sensitive adhesive label 5 to express pressure-sensitive adhesive strength, and issues the label.

In FIG. 1, the conveyance direction of the thermosensitive pressure-sensitive adhesive label 5 is defined as S. The conveyance direction S is directed from the right side to the left side in FIG. 1. The right side is defined as an upstream side of the conveyance direction S, and the left side is defined as a downstream side of the conveyance direction S. In the following description, the upstream side of the conveyance direction S is sometimes merely referred to as an upstream side, and the downstream side of the conveyance direction S is sometimes merely referred to as a downstream side.

Further, the inside surface of the sheet roll R corresponds to the one surface of the thermosensitive pressure-sensitive adhesive label 5, and a thermosensitive coloring layer 5a that is discolored by heating to be printed is formed on the one surface. Further, the outside surface of the sheet roll R corresponds to the other surface of the thermosensitive pressure-sensitive adhesive label 5, and a thermosensitive pressure-sensitive adhesive layer 5b (thermosensitive layer) that is heated to express pressure-sensitive adhesive strength is formed on the other surface.

The thermal printer 1 includes a printing unit 2 for performing printing with respect to the thermosensitive coloring layer 5a by heating the thermosensitive coloring layer 5a from the one surface side (upper side in FIG. 1) of the thermosensitive pressure-sensitive adhesive label 5 to be conveyed, a cutter unit 3 for cutting the thermosensitive pressure-sensitive adhesive label 5 unrolled from the sheet roll R to a desired length, and a pressure-sensitive adhesive strength expressing unit 4 for causing the thermosensitive pressure-sensitive adhesive layer 5b to express pressure-sensitive adhesive strength by heating the thermosensitive pressure-sensitive adhesive layer 5b from the other surface side (lower side in FIG. 1) of the thermosensitive pressure-sensitive adhesive label 5. A thermal head according to the present invention is a thermal head 10 for expressing pressure-sensitive adhesive strength described later, and constitutes the pressure-sensitive adhesive strength expressing unit 4.

The printing unit 2 is placed on the downstream side of the sheet roll R and includes a first platen roller 51 and a printing thermal head 8. The printing thermal head 8 has a plurality of heat-generating elements (not shown) and is placed so as to face the thermosensitive coloring layer 5a of the thermosensitive pressure-sensitive adhesive label 5. Further, the first platen roller 51 is placed on an opposite side of the printing thermal head 8 with the thermosensitive pressure-sensitive adhesive label 5 interposed therebetween.

The printing thermal head 8 is biased to the first platen roller 51 side by a spring or the like (not shown). Therefore, the thermosensitive pressure-sensitive adhesive label 5 is interposed elastically between the printing thermal head 8 and the first platen roller 51. When the printing thermal head 8 is supplied with power from a power source (not shown), the plurality of heat-generating elements generate heat, and the thermosensitive coloring layer 5a of the thermosensitive pressure-sensitive adhesive label 5 is heated to be printed with letters, graphics, and the like. Further, when the first platen roller 51 is rotated by a drive source (not shown), the thermosensitive pressure-sensitive adhesive label 5 is conveyed while the thermosensitive coloring layer 5a and the printing thermal head 8 are in sliding contact with each other.

The cutter unit 3 is placed on the downstream side of the printing unit 2 and has a movable blade 55 and a fixed blade 57 on both sides of the thermosensitive pressure-sensitive adhesive label 5. The movable blade 55 is capable of reciprocating and sliding against the fixed blade 57 and cuts the printed thermosensitive pressure-sensitive adhesive label 5 to a desired length.

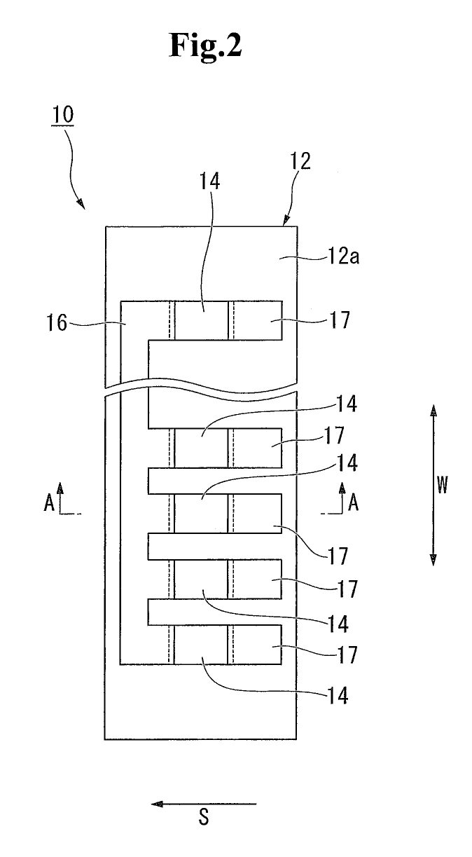

The pressure-sensitive adhesive strength expressing unit 4 is placed on the downstream side of the cutter unit 3 and includes a second platen roller 53 (corresponding to a “platen roller” in the claims) and the thermal head 10 for expressing pressure-sensitive adhesive strength (corresponding to a “thermal head” in the claims). The thermal head 10 for expressing pressure-sensitive adhesive strength includes a plurality of heat-generating elements 14 (see FIG. 2) as described later and is placed so as to face the thermosensitive pressure-sensitive adhesive layer 5b of the thermosensitive pressure-sensitive adhesive label 5. Further, the second platen roller 53 is placed on the opposite side of the thermal head 10 for expressing pressure-sensitive adhesive strength with the thermosensitive pressure-sensitive adhesive label 5 interposed therebetween.

The thermal head 10 for expressing pressure-sensitive adhesive strength is biased to the second platen roller 53 side by a spring or the like (not shown). Therefore, the thermosensitive pressure-sensitive adhesive label 5 is interposed elastically between the thermal head 10 for expressing pressure-sensitive adhesive strength and the second platen roller 53.

Then, when the thermal head 10 for expressing pressure-sensitive adhesive strength is supplied with power from a power source (not shown), the plurality of heat-generating elements 14 generate heat, and the thermosensitive pressure-sensitive adhesive layer 5b of the thermosensitive pressure-sensitive adhesive label 5 is heated to express pressure-sensitive adhesive strength. Further, when the second platen roller 53 is rotated by a drive source (not shown), the thermosensitive pressure-sensitive adhesive label 5 is conveyed while the thermosensitive pressure-sensitive adhesive layer 5b and the thermal head 10 for expressing pressure-sensitive adhesive strength are in sliding contact with each other.

Next, the thermal head 10 for expressing pressure-sensitive adhesive strength of this embodiment is described.

FIG. 2 is a plan view of the thermal head 10 for expressing pressure-sensitive adhesive strength.

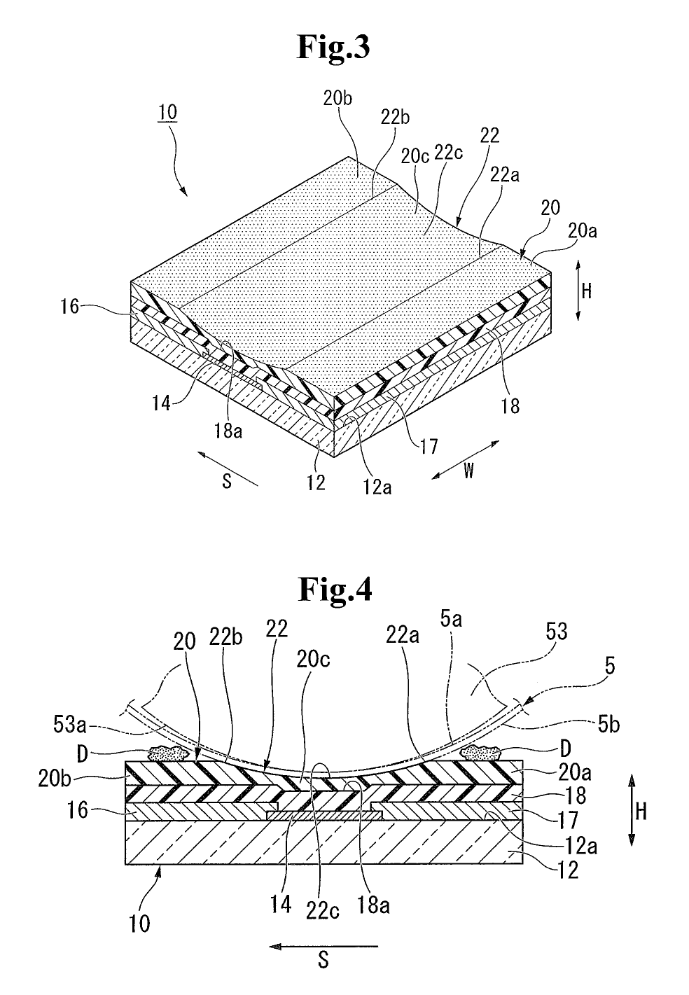

FIG. 3 is a cross-sectional perspective view of the thermal head 10 for expressing pressure-sensitive adhesive strength.

In FIG. 2, for ease of understanding, the protective layer 18 and a thermally active component adhesion preventing layer 20 (see FIG. 3) described later are omitted. Further, in FIGS. 2 and 3, the conveyance direction S of the thermosensitive pressure-sensitive adhesive label 5 is directed from the right side to the left side. The right side is defined as an upstream side and the left side is defined as a downstream side. Further, in the following, the width direction of the thermosensitive pressure-sensitive adhesive label 5 to be conveyed is defined as W, and the thickness direction of the thermal head 10 for expressing pressure-sensitive adhesive strength orthogonal to the conveyance direction S and the width direction W is defined as H.

As illustrated in FIG. 2, the thermal head 10 for expressing pressure-sensitive adhesive strength includes a substrate 12, the plurality of heat-generating elements 14 formed on a principal plane 12a of the substrate 12, and electrodes 16 and 17 connected to the heat-generating elements 14. Further, as illustrated in FIG. 3, the protective layer 18 covering the heat-generating elements 14 and the electrodes 16, 17, and the thermally active component adhesion preventing layer 20 covering the protective layer 18 are formed on the principal plane 12a of the substrate 12.

As illustrated in FIG. 2, the substrate 12 is shaped to be substantially rectangular in a planar view, having a short side in the conveyance direction S of the thermosensitive pressure-sensitive adhesive label 5 (see FIG. 1) and a long side in the width direction W of the thermosensitive pressure-sensitive adhesive label 5 (see FIG. 1). The substrate 12 is formed of, for example, ceramics and has an insulating property.

On the principal plane 12a of the substrate 12, the plurality of heat-generating elements 14 are formed. The heat-generating element 14 is shaped to be substantially rectangular in a planar view. The heat-generating element 14 is a heat-generating resistive element for generating heat when supplied with a current. The heat-generating elements 14 are arranged at a substantially equal interval in the width direction W substantially at the center of the principal plane 12a of the substrate 12 in the conveyance direction S. The heat-generating element 14 is formed of, for example, a heat-generating resistive material such as tantalum (Ta) and silicon oxide (SiO₂).

Further, the electrodes 16 and 17 connected to the heat-generating elements 14 are formed on the principal plane 12a of the substrate 12. The electrodes 16 and 17 are formed of metal having a high electric conductivity such as gold (Au), copper (Cu), or aluminum (Al). The electrodes 16 and 17 are respectively formed so as to cover ends of the heat-generating elements 14 in the conveyance direction S and connected electrically to the heat-generating elements 14. Further, the electrodes 16 and 17 are electrically connected to a power source (not shown) in such a manner that the heat-generating elements 14 are supplied with a current from the power source through the electrodes 16 and 17.

As illustrated in FIG. 3, the protective layer 18 is formed so as to cover the heat-generating elements 14 and the electrodes 16 and 17 on the principal plane 12a of the substrate 12. The protective layer 18 prevents the surfaces of the heat-generating elements 14 and the electrodes 16 and 17 from being oxidized. Further, the protective layer 18 prevents the thermosensitive pressure-sensitive adhesive label 5 and the heat-generating elements 14 and the electrodes 16 and 17 from coming into sliding contact with each other to be worn away, when the thermosensitive pressure-sensitive adhesive label 5 is conveyed.

The protective layer 18 is formed of, for example, hard ceramics such as Si—O—N or Si—Al—O—N. The thickness of the protective layer 18 is formed so as to be substantially uniform on the heat-generating elements 14 and the electrodes 16 and 17. As described above, only the ends of the heat-generating elements 14 in the conveyance direction S are covered with the electrodes 16 and 17. Therefore, when the protective layer 18 having substantially uniform thickness is formed on the heat-generating elements 14 and the electrodes 16 and 17, a concave 18a having a different height in the thickness direction H, compared with those of the upstream side and the downstream side of the heat-generating elements 14, is formed in a region covering the surface of the heat-generating elements 14 between the electrodes 16 and 17.

FIG. 4 is a cross-sectional side view taken along the line A-A of FIG. 2. In FIG. 4, for ease of description, the thermosensitive pressure-sensitive adhesive label 5 and the second platen roller 53 are indicated by alternate long and two short dashes lines.

As illustrated in FIG. 4, the thermally active component adhesion preventing layer 20 is formed on the uppermost surface of the principal plane 12a of the substrate 12.

The thermally active component adhesion preventing layer 20 is formed continuously between the upstream side and the downstream side of the conveyance direction S across the heat-generating elements 14 so as to cover the underlying protective layer 18.

The thermally active component adhesion preventing layer 20 includes at least an upstream portion 20a formed on the upstream side in the conveyance direction S across the heat-generating elements 14 and a downstream portion 20b formed on the downstream side in the conveyance direction S across the heat-generating elements 14.

The thermally active component adhesion preventing layer 20 of this embodiment includes the upstream portion 20a covering the electrode 17 on the upstream side, the downstream portion 20b covering the electrode 16 on the downstream side, and a center portion 20c covering the heat-generating elements 14 between the upstream portion 20a and the downstream portion 20b. The upstream portion 20a, the downstream portion 20b, and the center portion 20c are formed continuously.

The thermally active component adhesion preventing layer 20 is in sliding contact with the thermosensitive pressure-sensitive adhesive layer 5b, when the thermosensitive pressure-sensitive adhesive label 5 is conveyed while being interposed between the heat-generating elements 14 and the second platen roller 53.

The thermally active component adhesion preventing layer 20 is formed of a material that has low surface energy and is excellent in water repellency and oil repellency, for example, a silicon-based resin or a fluorine-based resin. Thus, the thermally active component adhesion preventing layer 20 has a property of preventing the adhesion of the thermally active component D of the thermosensitive pressure-sensitive adhesive layer 5b.

Further, the thermally active component adhesion preventing layer 20 may be formed of a material obtained by adding powder of an oxide, a nitride, or an oxynitride of silicon, a silicon-based alloy, titanium, a titanium-based alloy, tantalum, or a tantalum-based alloy to a fluorine-based resin. This enables the formation of the thermally active component adhesion preventing layer 20 that has low surface energy, keeps property excellent in water repellency and oil repellency, and is excellent in abrasion resistance.

Further, the thermally active component adhesion preventing layer 20 may be formed of a material obtained by adding metal or carbon to a fluorine-based resin. This allows the thermally active component adhesion preventing layer 20 to have conductivity while having low surface energy and keeping property excellent in water repellency and oil repellency. Then, even when the thermosensitive pressure-sensitive adhesive layer 5b and the thermally active component adhesion preventing layer 20 come into sliding contact with each other to generate static electricity when the thermosensitive pressure-sensitive adhesive label 5 is conveyed, static electricity can be discharged from the thermally active component adhesion preventing layer 20 gradually. Accordingly, electrostatic breakdown of electronic elements such as the heat-generating elements 14 can be prevented.

It is desired that the hardness of the thermally active component adhesion preventing layer 20 be set, for example, in a range of 2 B to 5 B in terms of pencil hardness, although depending upon the kind of the thermosensitive pressure-sensitive adhesive label 5. The hardness of the thermally active component adhesion preventing layer 20 can be adjusted by, for example, the kind and addition amount of an additive to a material.

In the case where the adhesion between the surface of the protective layer 18 and a resin material for forming the thermally active component adhesion preventing layer 20 is poor, the thermally active component adhesion preventing layer 20 may be formed through an intermediate film (primer) that is formed of a silane coupling agent or the like and has excellent adhesion. Further, the thermally active component adhesion preventing layer 20 may be formed by solving the problem of surface roughness of the protective layer 18 by mechanical polishing or chemical polishing to enhance the adhesion with respect to a resin material.

In a surface 22 of the thermally active component adhesion preventing layer 20, an upstream portion surface 22a formed in the upstream portion 20a of the thermally active component adhesion preventing layer 20, a center portion surface 22c formed in the center portion 20c, and a downstream portion surface 22b formed in the downstream portion 20b are formed continuously along an outer circumferential surface 53a of the second platen roller 53. The surface 22 of the thermally active component adhesion preventing layer 20 is a sliding-contact surface that comes into sliding contact with the thermosensitive pressure-sensitive adhesive layer 5b when the thermosensitive pressure-sensitive adhesive label 5 is conveyed.

The surface 22 of the thermally active component adhesion preventing layer 20 has a substantially arc shape that is substantially concentric with the second platen roller 53 when viewed from the width direction W.

The radius of curvature of the surface 22 of the thermally active component adhesion preventing layer 20 is set to be slightly larger than that of the outer circumferential surface 53a of the second platen roller 53.

By forming the surface 22 of the thermally active component adhesion preventing layer 20 as described above, the center portion surface 22c and the thermosensitive pressure-sensitive adhesive layer 5b of the thermosensitive pressure-sensitive adhesive label 5 can be reliably brought into surface contact with each other, when the thermosensitive pressure-sensitive adhesive label 5 is conveyed while being interposed between the thermal head 10 for expressing pressure-sensitive adhesive strength and the second platen roller 53. Thus, the heat generated by the heat-generating elements 14 can be transmitted to the thermosensitive pressure-sensitive adhesive layer 5b without fail, and the generated thermally active component D can be conveyed to the downstream side of the heat-generating elements 14 without being caught on into the surface 22 of the thermally active component adhesion preventing layer 20. Further, a gap is not formed between the second platen roller 53 and the center portion surface 22c, and hence, the thermally active component D does not remain in a gap between the second platen roller 53 and the thermally active component adhesion preventing layer 20.

Further, a slight gap is formed between the outer circumferential surface 53a of the second platen roller 53 and the upstream portion surface 22a and the downstream portion surface 22b of the thermally active component adhesion preventing layer 20. Thus, the thermosensitive pressure-sensitive adhesive label 5 is conveyed without being caught on into the upstream portion surface 22a and the downstream portion surface 22b while coming into surface contact with the center portion surface 22c. Further, the thermally active component D of the thermosensitive pressure-sensitive adhesive layer 5b is removed without being caught on the downstream portion surface 22b.

Further, the surface 22 of the thermally active component adhesion preventing layer 20 is formed along the outer circumferential surface 53a of the second platen roller 53, and hence the center portion 20c of the thermally active component adhesion preventing layer 20 is formed thinner than the upstream portion 20a and the downstream portion 20b. Therefore, when heat is transmitted from the heat-generating elements 14 to the thermosensitive pressure-sensitive adhesive layer 5b via the thermally active component adhesion preventing layer 20, a decrease in a heat conduction efficiency is suppressed.

According to the present invention, the surface 22 of the thermally active component adhesion preventing layer 20 is formed without any step along the outer circumferential surface 53a of the second platen roller 53, and hence, the thermosensitive pressure-sensitive adhesive layer 5b of the thermosensitive pressure-sensitive adhesive label 5 and the surface 22 of the thermally active component adhesion preventing layer 20 can come into surface contact with each other, when the thermosensitive pressure-sensitive adhesive label 5 is conveyed while being interposed between the second platen roller 53 and the heat-generating elements 14. Herein, the thermally active component adhesion preventing layer 20 has a property of preventing the adhesion of the thermally active component D. Therefore, the thermally active component D adhering to the thermosensitive pressure-sensitive adhesive layer 5b of the thermosensitive pressure-sensitive adhesive label 5 is conveyed to the downstream side of the heat-generating elements 14 to be removed from the region right above the heat-generating elements 14 without being caught on the surface 22 of the thermally active component adhesion preventing layer 20 and without remaining in a gap between the second platen roller 53 and the thermally active component adhesion preventing layer 20.

Accordingly, the thermally active component D can be prevented from remaining in the periphery of the heat-generating elements 14 and the thermally active component D can be prevented from adhering to the region above the heat-generating elements 14 and the periphery of the heat-generating element.

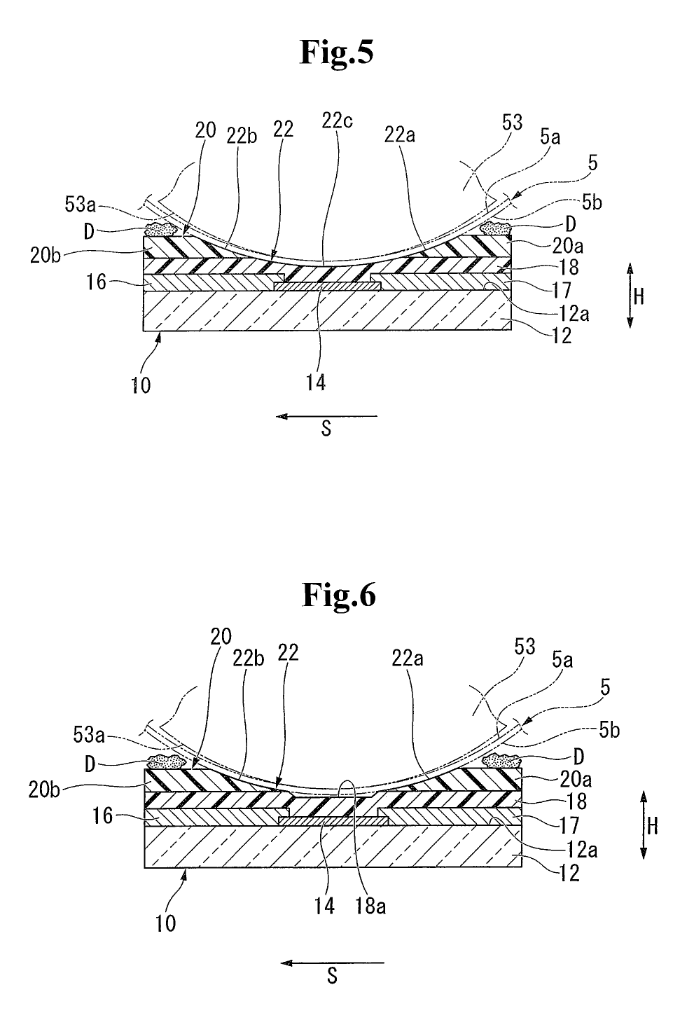

FIG. 5 is a cross-sectional side view of the thermal head 10 for expressing pressure-sensitive adhesive strength in a first modified example of the embodiment. In FIG. 5, for ease of description, the thermosensitive pressure-sensitive adhesive label 5 and the second platen roller 53 are indicated by alternate long and two short dashes lines, in the same way as in FIG. 4.

As illustrated in FIG. 4, in the thermal head 10 for expressing pressure-sensitive adhesive strength of the embodiment, the thermally active component adhesion preventing layer 20 includes the upstream portion 20a, the downstream portion 20b, and the center portion 20c, and the upstream portion 20a, the downstream portion 20b, and the center portion 20c are formed continuously.

In contrast, as illustrated in FIG. 5, the thermal head 10 for expressing pressure-sensitive adhesive strength of the first modified example is different from the thermal head 10 for expressing pressure-sensitive adhesive strength of the embodiment in that the thermally active component adhesion preventing layer 20 includes the upstream portion 20a and the downstream portion 20b, and the upstream portion 20a and the downstream portion 20b are formed separately. Detailed descriptions of portions with the same configurations as those of the embodiment are omitted.

As illustrated in FIG. 5, the thermally active component adhesion preventing layer 20 of the thermal head 10 for expressing pressure-sensitive adhesive strength of the first modified example includes the upstream portion 20a covering the electrode 17 on the upstream side and the downstream portion 20b covering the electrode 16 on the downstream side. Further, the protective layer 18 is exposed from between the upstream portion 20a and the downstream portion 20b of the thermally active component adhesion preventing layer 20.

The upstream portion surface 22a is formed on the upstream portion 20a of the thermally active component adhesion preventing layer 20. Further, the downstream portion surface 22b is formed on the downstream portion 20b of the thermally active component adhesion preventing layer 20. Further, the center portion surface 22c is formed on the protective layer 18 exposed from between the upstream portion 20a and the downstream portion 20b of the thermally active component adhesion preventing layer 20. The upstream portion surface 22a, the downstream portion surface 22b, and the center portion surface 22c are formed continuously along the outer circumferential surface 53a of the second platen roller 53 and functions as a sliding-contact surface that comes into sliding contact with the thermosensitive pressure-sensitive adhesive layer 5b when the thermosensitive pressure-sensitive adhesive label 5 is conveyed.

According to the first modified example of the embodiment, the surfaces (upstream portion surface 22a, downstream portion surface 22b, and center portion surface 22c ), which are formed continuously between the upstream side and the downstream side of the heat-generating elements 14 and with which the thermosensitive pressure-sensitive adhesive layer 5b of the thermosensitive pressure-sensitive adhesive label 5 comes into surface contact, can be formed without covering the heat-generating elements 14 with the thermally active component adhesion preventing layer 20. Thus, the thermal head 10 for expressing pressure-sensitive adhesive strength, which is excellent in a heat conduction efficiency in addition to the effects of the embodiment, can be formed.

FIG. 6 is a cross-sectional side view of the thermal head 10 for expressing pressure-sensitive adhesive strength in a second modified example of the embodiment. In FIG. 6, for ease of description, the thermosensitive pressure-sensitive adhesive label 5 and the second platen roller 53 are indicated by alternate long and two short dashes lines, in the same way as in FIGS. 4 and 5.

As illustrated in FIG. 4, in the thermal head 10 for expressing pressure-sensitive adhesive strength of the embodiment, the surface 22 of the thermally active component adhesion preventing layer 20 is formed continuously by the upstream portion 22a, the downstream portion 22b, and the center portion 20c. Further, as illustrated in FIG. 5, in the thermal head 10 for expressing pressure-sensitive adhesive strength of the first modified example, the center portion surface 22c is formed on the protective layer 18, and the upstream portion surface 22a, the downstream portion surface 22b, and the center portion surface 22c are formed continuously.

In contrast, as illustrated in FIG. 6, the thermal head 10 for expressing pressure-sensitive adhesive strength of the second modified example is different from the thermal head 10 for expressing pressure-sensitive adhesive strength of the embodiment and the first modified example in that the thermal head 10 for expressing pressure-sensitive adhesive strength of the second modified example does not include the center portion surface 22c, and the upstream portion surface 22a and the downstream portion surface 22b are not formed continuously. Detailed descriptions of portions with the same configurations as those of the embodiment are omitted.

As illustrated in FIG. 6, in the same way as in the first modified example, the thermal head 10 for expressing pressure-sensitive adhesive strength of the second modified example includes the upstream portion 20a formed on the upstream side from the heat-generating elements 14 and the downstream portion 20b formed on the downstream side from the heat-generating elements 14. Further, the concave 18a of the protective layer 18 is exposed from between the upstream portion 20a and the downstream portion 20b.

Further, the upstream portion 20a of the thermally active component adhesion preventing layer 20 is provided with the upstream portion surface 22a, and the downstream portion 20b is provided with the downstream portion surface 22b. More specifically, the upstream portion surface 22a and the downstream portion surface 22b are formed separately with the concave 18a formed on the heat-generating element 14 interposed therebetween. The upstream portion surface 22a and the downstream portion surface 22b are formed along the outer circumferential surface 53a of the second platen roller 53.

According to the second modified example of the embodiment, the surfaces (upstream portion surface 22a and downstream portion surface 22b), which are formed on the upstream side and the downstream side of the heat-generating elements 14 and with which the thermosensitive pressure-sensitive adhesive layer 5b of the thermosensitive pressure-sensitive adhesive label 5 comes into surface contact, can be formed without covering the heat-generating elements 14 with the thermally active component adhesion preventing layer 20. Thus, the thermal head 10 for expressing pressure-sensitive adhesive strength, which is excellent in a heat conduction efficiency in addition to the effects of the embodiment, can be formed.

Hereinafter, a method of producing the above-mentioned thermal head 10 for expressing pressure-sensitive adhesive strength of the embodiment is described.

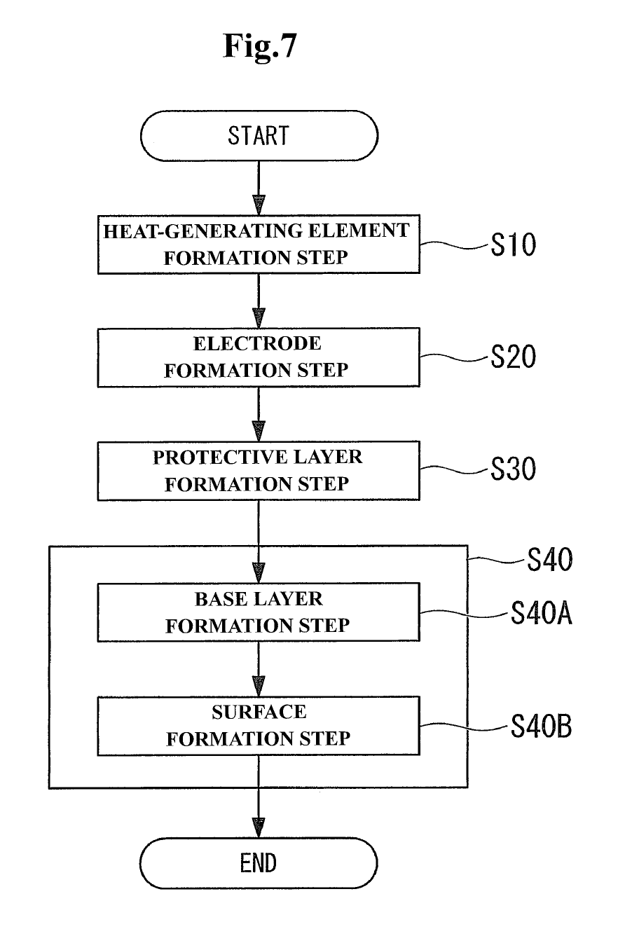

FIG. 7 is a flowchart of a method of producing the thermal head 10 for expressing pressure-sensitive adhesive strength.

As illustrated in FIG. 7, the method of producing the thermal head 10 for expressing pressure-sensitive adhesive strength of this embodiment includes a heat-generating element formation step S10, an electrode formation step S20, a protective layer formation step S30, and a thermally active component adhesion preventing layer formation step S40.

In the heat-generating element formation step S10, the plurality of heat-generating elements 14 are formed on the principal plane 12a of the substrate 12 (see FIG. 2). Specifically, a heat-generating resistive material such as Ta—SiO₂ is formed into a film on the principal plane 12a of the substrate 12 by, for example, sputtering, CVD, or vapor deposition. After that, the film is patterned to a predetermined outer shape by photolithography to form the plurality of heat-generating elements 14. In this embodiment, the film is patterned so that the outer shape of the heat-generating element 14 becomes substantially rectangular in a planar view, as illustrated in FIG. 2.

In the electrode formation step S20, the electrodes 16 and 17 electrically connected to the plurality of heat-generating elements 14 are formed on the principal plane 12a of the substrate 12 (see FIG. 2). Specifically, metal having a high conductivity such as Au, Cu, or Al is formed into a film by, for example, sputtering, CVD, or vapor deposition on the principal plane 12a of the substrate 12. After that, the film is patterned to a predetermined outer shape to form the electrodes 16 and 17 by, for example, photolithography. In this embodiment, as illustrated in FIG. 2, the film is patterned on the downstream side and the upstream side of the heat-generating elements 14 to form the electrodes 16 and 17. The electrodes 16 and 17 may be formed by, for example, screen printing.

In the protective layer formation step S30, the protective layer 18 covering the heat-generating elements 14 and the electrodes 16 and 17 is formed on the principal plane 12a of the substrate 12 (see FIG. 3). Specifically, hard ceramics such as Si—O—N or Si—Al—O—N are formed into a film so as to overlap the heat-generating elements 14 and the electrodes 16 and 17 on the principal plane 12a of the substrate 12 by, for example, sputtering, CVD, or vapor deposition to form the protective layer 18.

In the thermally active component adhesion preventing layer formation step S40, the thermally active component adhesion preventing layer 20 that comes into sliding contact with the thermosensitive pressure-sensitive adhesive layer 5b of the thermosensitive pressure-sensitive adhesive label 5 is formed on the upstream side and the downstream side of the conveyance direction S of the thermosensitive pressure-sensitive adhesive label 5 with the heat-generating element 14 interposed therebetween.

As illustrated in FIG. 7, the thermally active component adhesion preventing layer formation step S40 includes a base layer formation step S40A and a surface formation step S40B. Hereinafter, each step is described.

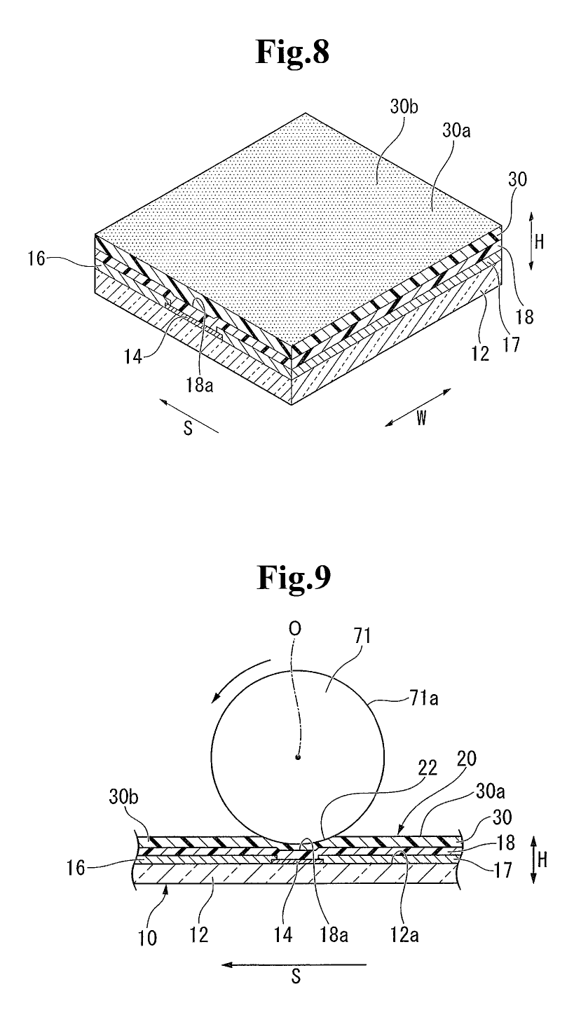

FIG. 8 is an explanatory diagram of the base layer formation step S40A.

As illustrated in FIG. 8, in the base layer formation step S40A, a base layer 30 made of a base material 30b that is to form the thermally active component adhesion preventing layer 20 later is formed so as to overlap the protective layer 18. As the base material 30b, a material that has low surface energy and is excellent in water repellency and oil repellency such as a silicone-based resin or a fluorine-based resin is used, as described above.

In the base layer formation step S40A, the base material 30b is applied to the entire surface of the protective layer 18. More specifically, in the base layer formation step S40A, the base material 30b can be applied to the protective layer 18 without masking, and hence, the base layer formation step S40A can be performed easily.

The base material 30b is applied to the protective layer 18 by, for example, screen printing. Thus, as illustrated in FIG. 8, an outer surface 30a of the base layer 30 is formed flatly. The base material 30b may be applied to the protective layer 18 by dipping, spraying, or brush coating instead of screen printing. Further, depending upon the characteristics of the base material 30b, the application of the base material 30b may pass through a drying step by thermal curing, UV-curing, agent solution reaction, chemical reaction with water or oxygen, or evaporation of a contained agent.

FIG. 9 is an explanatory diagram of the surface formation step S40B.

As illustrated in FIG. 9, in the surface formation step S40B, the base layer 30 is processed, thereby forming the surface 22 (see FIG. 4) of the thermally active component adhesion preventing layer 20, which is formed continuously between the upstream side and the downstream side of the conveyance direction S with the heat-generating element 14 interposed therebetween and is formed along the outer circumferential surface 53a of the second platen roller 53.

In the surface formation step S40B, the surface 22 of the thermally active component adhesion preventing layer 20 is formed by bringing an outer circumferential surface 71 a of a polishing roller 71 having a diameter substantially equal to that of the second platen roller 53 (see FIG. 4) into contact with the base layer 30 to polish the base layer 30.

Specifically, the polishing roller 71 having a diameter substantially equal to or slightly larger than that of the second platen roller 53 (see FIG. 4) is prepared. The outer circumferential surface 71 a of the polishing roller 71 is a polishing surface having a predetermined surface roughness over the entire circumference. Then, the surface 22 of the thermally active component adhesion preventing layer 20 is formed by bringing the outer circumferential surface 71a of the polishing roller 71 into contact with the outer surface 30a of the base layer 30 to polish the outer surface 30a while rotating the polishing roller 71 around a center axis O.

Thus, the surface 22 of the thermally active component adhesion preventing layer 20 having a shape following the outer circumferential surface 53a (see FIG. 4) of the second platen roller 53 is formed easily with good precision merely by polishing the base layer 30 with the polishing roller 71. Further, the polishing amount of the base layer 30 can be adjusted easily merely by adjusting the relative position between the polishing roller 71 and the base layer 30. This enables the base layer 30 covering the heat-generating elements 14 to be formed to a desired thickness, and hence, the thermal head 10 for expressing pressure-sensitive adhesive strength having a desired heat conduction efficiency can be formed.

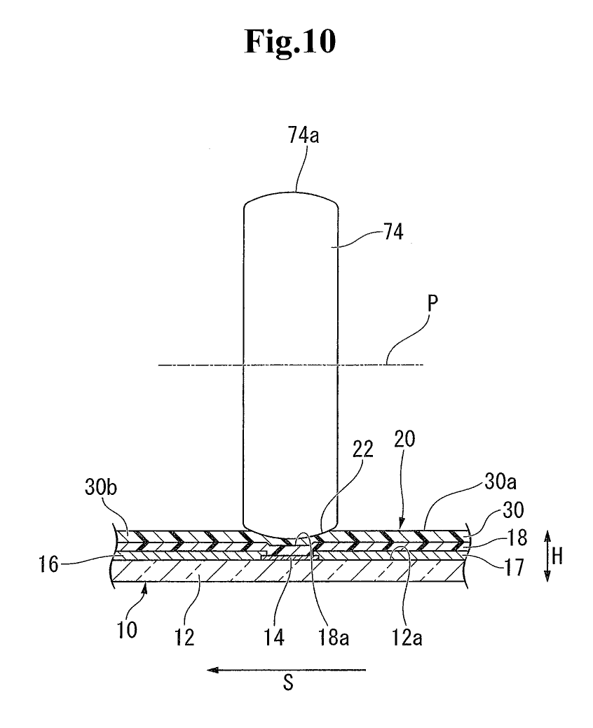

FIG. 10 is an explanatory diagram of the surface formation step S40B using a disk grinder 74.

As illustrated in FIG. 10, in the surface formation step S40B, the surface 22 of the thermally active component adhesion preventing layer 20 may be formed by bringing the side surface 74a of the disk grinder 74 into contact with the base material 30 to polish the base material 30.

Specifically, the disk grinder 74 whose radius of curvature of the side surface 74a is substantially equal to or slightly larger than that of the outer circumferential surface 53a (see FIG. 4) of the second platen roller 53 is prepared. The side surface 74a of the disk grinder 74 functions as a polishing surface having a predetermined surface roughness over the entire circumference. Then, the surface 22 of the thermally active component adhesion preventing layer 20 is formed by bringing the side surface 74a of the disk grinder 74 into contact with the outer surface 30a of the base layer 30 to polish the outer surface 30a while rotating the disk grinder 74 around a center axis P.

Thus, the surface 22 of the thermally active component adhesion preventing layer 20 having a shape following the outer circumferential surface 53a (see FIG. 4) of the second platen roller 53 can be formed easily with good precision merely by polishing the base layer 30 with the disk grinder 74. Further, in the same way as described above, the polishing amount of the base layer 30 can be adjusted easily merely by adjusting the relative position between the disk grinder 74 and the base layer 30, and hence, the thermal head 10 for expressing pressure-sensitive adhesive strength having a desired heat conduction efficiency can be formed.

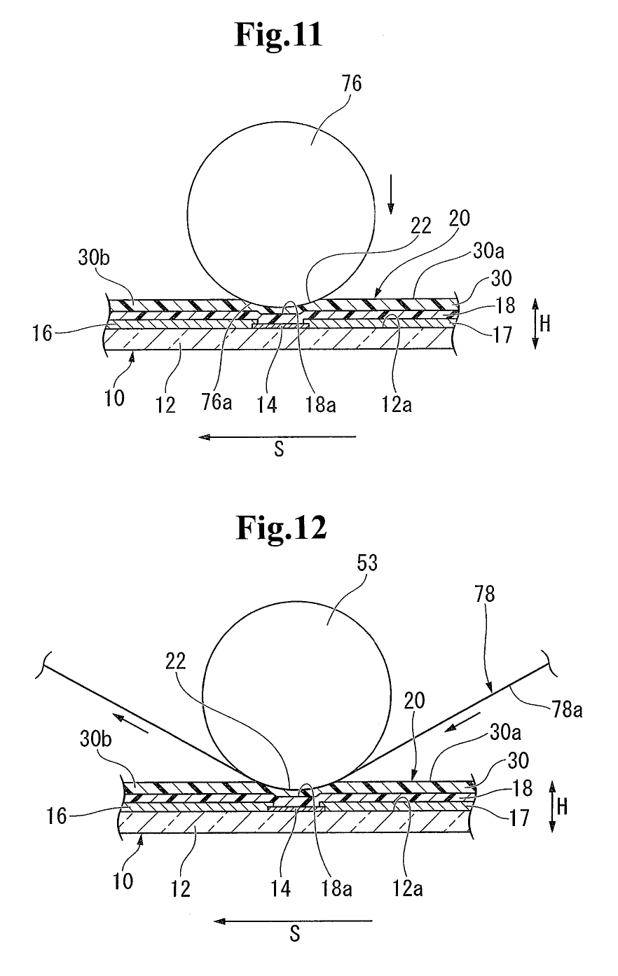

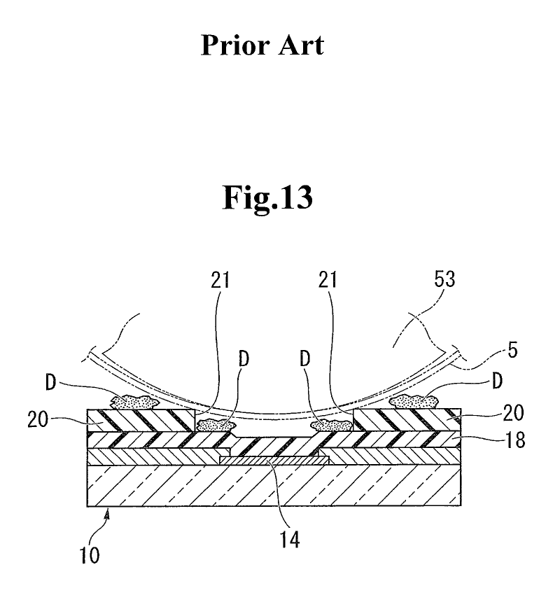

FIG. 11 is an explanatory diagram of the surface formation step S40B using a die 76.

As illustrated in FIG. 11, in the surface formation step S40B, the surface 22 of the thermally active component adhesion preventing layer 20 may be formed by pressing an outer circumferential surface 76a of the die 76 against the base layer 30.

Specifically, the die 76 whose radius of curvature of the outer circumferential surface 76a is substantially equal to or slightly larger than that of the outer circumferential surface 53a (see FIG. 4) of the second platen roller 53 is prepared. Then, the surface 22 of the thermally active component adhesion preventing layer 20 is formed by bringing the outer circumferential surface 76a of the die 76 into contact with the outer surface 30a of the base layer 30 to press the outer surface 30a.

Thus, the surface 22 of the thermally active component adhesion preventing layer 20 having a shape following the outer circumferential surface 53a (see FIG. 4) of the second platen roller 53 can be formed easily with good precision merely by pressing the outer circumferential surface 76a of the die 76 against the base layer 30. Further, the base layer 30 covering the heat-generating elements 14 can be formed to a desired thickness by adjusting a pressure force, and hence, the thermal head 10 for expressing pressure-sensitive adhesive strength having a desired heat conduction efficiency can be formed.

FIG. 12 is an explanatory diagram of the surface formation step S40B using a polishing sheet 78.

As illustrated in FIG. 12, in the surface formation step S40B, the surface 22 of the thermally active component adhesion preventing layer 20 may be formed by conveying the polishing sheet 78 by the second platen roller 53 and bringing the polishing sheet 78 into sliding contact with the base layer 30 to polish the base layer 30.

Specifically, the polishing sheet 78 provided with a polishing surface 78a with a predetermined surface roughness is prepared. Then, the polishing sheet 78 is placed between the base layer 30 and the second platen roller 53 while the polishing surface 78a is placed so as to face the outer surface 30a of the base layer 30. Then, the second platen roller 53 is rotated while being pressed against the substrate 12 side to convey the polishing sheet 78, and hence the outer surface 30a of the base layer 30 is polished with the polishing surface 78a of the polishing sheet 78 to form the surface 22 of the thermally active component adhesion preventing layer 20.

Accordingly, the surface 22 of the thermally active component adhesion preventing layer 20 having a shape following the outer circumferential surface 53a of the second platen roller 53 can be formed easily with good precision without using a tool by conveying the polishing sheet 78. Further, the polishing amount can be adjusted easily, and hence, the base layer 30 covering the heat-generating elements 14 can be formed to a desired thickness and the heat-generating elements 14 can be exposed from the base layer 30. Thus, the thermal head 10 for expressing pressure-sensitive adhesive strength having a desired heat conduction efficiency can be formed.

When the above-mentioned surface formation step S40B is completed, the production step of the thermal head 10 for expressing pressure-sensitive adhesive strength is completed, and the thermal head 10 for expressing pressure-sensitive adhesive strength illustrated in FIG. 3 is obtained.

According to the related art, it is necessary to form the base layer 30 of the thermally active component adhesion preventing layer 20 by masking the positions corresponding to the heat-generating elements 14 so that the thermally active component adhesion preventing layer 20 is not formed in regions right above the heat-generating elements 14, for the purpose of preventing a decrease in a heat conduction efficiency. Herein, the mask is formed by, for example, photolithography, and hence, the step is very complicated. However, according to this embodiment, after the base layer 30 of the thermally active component adhesion preventing layer 20 is formed so as to overlap the heat-generating elements 14, the surface processing is performed along the outer circumferential surface 53a of the second platen roller 53. Therefore, it is not necessary to mask the positions corresponding to the heat-generating elements 14. Thus, the thermally active component adhesion preventing layer 20 having the surface 22 along the outer circumferential surface 53a of the second platen roller 53 can be formed easily.

Further, in the related art, in order to ensure a satisfactory heat conduction efficiency, it is necessary to form the thermally active component adhesion preventing layer 20 thin. In order to form the thermally active component adhesion preventing layer 20 thin, it is necessary to use, for example, a silicone-based resin. However, the material itself is expensive, which results in a high production cost. However, according to this embodiment, the surface 22 of the thermally active component adhesion preventing layer 20 is formed by processing the thick base layer 30, and hence, the thermally active component adhesion preventing layer 20 can be formed to a desired thickness by adjusting a processing amount. Further, the base layer 30 before being processed can be formed thick, and hence, a material for forming the thermally active component adhesion preventing layer 20 is not limited. Thus, the thermal head 10 for expressing pressure-sensitive adhesive strength having a desired heat conduction efficiency can be formed at low cost.

The technical range of the present invention is not limited to the above-mentioned embodiment and can be variously modified within the scope not deviating from the spirit of the present invention.

The thermal head 10 for expressing pressure-sensitive adhesive strength of this embodiment is applied to the pressure-sensitive adhesive strength expressing unit 4 for heating the thermosensitive pressure-sensitive adhesive layer 5b to express pressure-sensitive adhesive strength. However, the thermal head 10 for expressing pressure-sensitive adhesive strength may be applied as the printing thermal head 8 of the printing unit 2 for heating the thermosensitive coloring layer 5a for printing. Even in this case, the present invention is preferred particularly for the thermosensitive pressure-sensitive adhesive label 5 having the thermosensitive pressure-sensitive adhesive layer 5b in terms of preventing the adhesion of a thermosensitive coloring component that has come off the thermosensitive coloring layer 5a of the thermosensitive pressure-sensitive adhesive label 5 to be an obstacle for printing and in terms of conveying the thermosensitive coloring component to the downstream side of the heat-generating elements 14 to remove it.

A material constituting the thermally active component adhesion preventing layer 20 is not limited to the embodiment, and a material that has low surface energy and is excellent in water repellency and oil repellency can be used widely. Thus, as the material constituting the thermally active component adhesion preventing layer 20, for example, an organic material containing a trace amount of powder such as SiAlON, SiO₂, SiC, Si—N, TiC, Ti—C, TiO₂, C (including diamond), Zr, or ZrN may be used.

What is claimed is:

1. A thermal head, comprising a heat-generating element on a principal plane of a substrate,
the thermal head being configured to heat a thermosensitive layer of a thermosensitive label conveyed while being interposed between the heat-generating element and a platen roller opposed to the heat-generating element,
wherein the principal plane of the substrate has a thermally active component adhesion preventing layer formed thereon, which comes into sliding contact with the thermosensitive layer and is formed at least on an upstream side and a downstream side of the heat-generating element in a conveyance direction of the thermosensitive label, and
wherein a surface of the thermally active component adhesion preventing layer is formed in a shape following an outer circumferential surface of the platen roller.

2. A thermal head according to claim 1,
wherein the thermally active component adhesion preventing layer is formed continuously between the upstream side and the downstream side of the heat-generating element in the conveyance direction so as to cover the heat-generating element, and
wherein the surface of the thermally active component adhesion preventing layer is formed in the shape following the outer circumferential surface of the platen roller between the upstream side and the downstream side of the heat-generating element in the conveyance direction.

3. A thermal head according to claim 1, wherein the thermosensitive label comprises a thermosensitive pressure-sensitive adhesive label, and the thermosensitive layer comprises a thermosensitive pressure-sensitive adhesive layer for expressing pressure-sensitive adhesive strength by heating.

4. A thermal head according to claim 1, wherein the thermally active component adhesion preventing layer contains one of a silicone-based resin and a fluorine-based resin as a main component.

5. A thermal head according to claim 1, wherein the thermally active component adhesion preventing layer contains, as a main component, a material obtained by adding powder of one of an oxide, a nitride, and an oxynitride of one of silicon, a silicon-based alloy, titanium, a titanium-based alloy, tantalum, and a tantalum-based alloy to a fluorine-based resin.

6. A thermal head according to claim 1, wherein the thermally active component adhesion preventing layer contains, as a main component, a material obtained by adding one of metal and carbon to a fluorine-based resin.

7. A thermal head according to claim 2, wherein the thermosensitive label comprises a thermosensitive pressure-sensitive adhesive label, and the thermosensitive layer comprises a thermosensitive pressure-sensitive adhesive layer for expressing pressure-sensitive adhesive strength by heating.

8. A thermal head according to claim 7, wherein the thermally active component adhesion preventing layer contains one of a silicone-based resin and a fluorine-based resin as a main component.

9. A thermal head according to claim 7, wherein the thermally active component adhesion preventing layer contains, as a main component, a material obtained by adding powder of one of an oxide, a nitride, and an oxynitride of one of silicon, a silicon-based alloy, titanium, a titanium-based alloy, tantalum, and a tantalum-based alloy to a fluorine-based resin.

10. A thermal head according to claim 7, wherein the thermally active component adhesion preventing layer contains, as a main component, a material obtained by adding one of metal and carbon to a fluorine-based resin.

11. A thermal printer, comprising the thermal head according to claim 1.

12. A method of producing a thermal head comprising a heat-generating element on a principal plane of a substrate, the thermal head being configured to heat a thermosensitive layer of a thermosensitive label conveyed while being interposed between the heat-generating element and a platen roller opposed to the heat-generating element,
the method comprising forming a thermally active component adhesion preventing layer that comes into sliding contact with the thermosensitive layer on the principal plane of the substrate at least on an upstream side and a downstream side of the heat-generating element in a conveyance direction of the thermosensitive label,
wherein the forming a thermally active component adhesion preventing layer includes:
forming a base layer of the thermally active component adhesion preventing layer on the principal plane of the substrate so that the base layer overlaps the heat-generating element; and
after forming the base layer, forming a surface along an outer circumferential surface of the platen roller by processing the base layer at least on the upstream side and the downstream side of the heat-generating element in the conveyance direction of the thermosensitive label.

13. A method of producing a thermal head according to claim 12, wherein the forming a surface includes bringing an outer circumferential surface of a polishing roller having a diameter substantially equal to a diameter of the platen roller into contact with the base layer to polish the base layer.

14. A method of producing a thermal head according to claim 12,
wherein the forming a surface includes bringing a side surface of a disk grinder into contact with the base layer to polish the base layer, and
wherein the side surface of the disk grinder is formed on a curved surface having a radius of curvature substantially equal to a radius of curvature of the outer circumferential surface of the platen roller.

15. A method of producing a thermal head according to claim 12,
wherein the forming a surface includes pressing an outer circumferential surface of a die against the base layer, and
wherein the outer circumferential surface of the die is formed on a curved surface having a radius of curvature substantially equal to a radius of curvature of the outer circumferential surface of the platen roller.

16. A method of producing a thermal head according to claim 12, wherein the forming a surface includes conveying a polishing sheet with the platen roller and bringing the polishing sheet into sliding contact with the base layer to polish the base layer.
